(19) United States
(12) Patent Application Publication
(10) Pub. No.: US 2023/0301242 A1
(43) Pub. Date: Sep. 28, 2023

(54) POLYLACTIC ACID-BASED PLANTERS AND ASSOCIATED METHODS

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 18/191,433

(22) Filed: Mar. 28, 2023

Related U.S. Application Data
(60) Provisional application No. 63/362,004, filed on Mar. 28, 2022.

(51) Int. Cl. A01G 9/02; C08J 9/22; C08J 5/12

(52) U.S. Cl. CPC A01G 9/021; C08J 9/22; C08J 5/128; C08J 5/121; C08J 2367/04; C08J 2331/04

(57) ABSTRACT

Planters are provided. The planters include one or more molded foam articles that are formed from polylactic acid. Forming the molded foam articles from polylactic acid advantageously enables air and water transport through the walls of the planter, reduces the overall weight of the planter, enables highly customizable shapes and sizes of planters, and enables compostability of the planter.

### CROSS-REFERENCE TO RELATED APPLICATION

This application claim priority to U.S. Provisional Patent Application No. 63/362,004, filed Mar. 28, 2022, which is incorporated herein by reference.

### FIELD OF THE DISCLOSURE

This disclosure relates generally to molded foam articles and, in particular, relates to planters composed of molded foam articles formed from polylactic acid.

### BACKGROUND

Until the late twentieth century, planters were most commonly formed from clay or terra cotta, a form factor and material that is still used today. Clay planters advantageously permit air and water to pass through the walls of the planter, enabling growth of plants that flourish in drier soil and providing a built-in water regulation system that requires more watering but ensure fresh water is always present. Furthermore, the microbial cultures in soil depend on a particular combination of oxygen, water, and root structure. Certain microbes such as nitrogen-fixing microbes permit air from the environment to be fixed in the soil as solid nitrogen, further enabling plant growth without the need for nitrogenized fertilizer. However, clay planters are heavy and prone to breaking.

The introduction and widespread use of plastics in many consumer products resulted in the plastic planter, which quickly grew to dominate the planter market as a cheap, durable, and lightweight alternative to clay planters. However, plastic planters are highly resistant to moisture and air transfer through the walls of the planter, resulting in increased disease and root rot. To counter this, plastic pots generally have holes for drainage, necessitating the use of plant “saucers” that collect drainage. Furthermore, specialty soils were developed that reduce the prevalence of disease. Plastic planters also have poorer temperature regulation because the relatively thin plastic walls provide little-to-no thermal insulation, further contributing to poor soil microbe culture and plant root health.

Plastic planters also contribute to waste as they are notoriously difficult to recycle. Since plastic planters have very few requirements, namely, light weight and appreciable rigidity, plastic planters are typically formed from low-cost resins that have high variability in plastic properties. This variability in properties and resin composition affects the necessary recycling conditions. Mechanical recycling also requires removal of all dirt and soil which contributes to water waste.

Decorative planter arrangements, characterized by a number of separate planters spaced apart in a decorative arrangement, are typically formed from a combination of a plastic planters and expandable polystyrene (EPS) pieces that act as holders to keep the planters in place. However, disposing of these planter arrangements is challenging because the EPS is not always easily separated from the plastic and soil waste, further contributing to waste.

Seedling cultivation typically involves placing a seed in a container and filling the container with a combination of soil, peat moss, compost, earthworm castings, vermiculite, and/or perlite. Since the seedling is small and fragile, watering the seedling is typically performed using capillary mats that transport water into the container without pouring water on top of the seeding. Specialty trays having many seedling containers, sometimes numbering around 100 seedlings, may be equipped with these capillary mats, enabling swift and efficient watering and growth of the seedlings. The specialty trays, like the decorative planter arrangements, above, are typically formed from EPS, but may also be formed from thermoformed polypropylene or molded paper coated with wax, polyfluoroalkyl substances, or silicone. However, each of these materials contribute to different microbial growth environments. Furthermore, each tray and each seedling container contributes to waste as these materials are not easily recycled or composted.

Hydroponic systems involve growing herbs or vegetables without soil. These systems are normally characterized by a plastic component that holds or suspends the plant allowing the roots of the plant to reach nutrient-enhanced liquid. As the plant grows, it must be transitioned to a new plastic housing because the plastic cannot “grow” in size as the plant grows.

Accordingly, improved planters are needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a decorative planter arrangement, in accordance with an embodiment of the disclosure.

FIG. 2 is a seedling planter tray, in accordance with an embodiment of the disclosure.

FIG. 3 is a hydroponic planter tray, in accordance with an embodiment of the disclosure.

FIG. 4 is a graph of soil temperatures, in accordance with an embodiment of the disclosure.

FIG. 5 is a graph of soil moisture, in accordance with an embodiment of the disclosure.

FIG. 6 is a graph of soil moisture, in accordance with an embodiment of the disclosure.

FIG. 7 is a graph of water absorption by bead foams, in accordance with an embodiment of the disclosure.

FIG. 8 is a graph of water absorption by bead foams, in accordance with an embodiment of the disclosure.

### DETAILED DESCRIPTION

Planters are provided herein including planters composed of one or more molded bead foam articles formed from polylactic acid. In particular, it has been unexpectedly discovered that forming the one or more molded bead foam articles from polylactic acid enables a planter having water and oxygen transfer through the walls of the planter that advantageously prevents disease, lowers soil cost, increases compostability, and reduces planter weight as compared to conventional clay or plastic planters. Furthermore, the molded bead foam article can be machined, adhered, and/or thermoformed from an initial shape to form the planter, enabling reusability of the PLA-based molded bead foam articles in ways superior to or, in some cases, impossible in a comparable EPS molded foam article.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

Planters

Planters are disclosed herein. In some embodiments, the planters includes at least one molded bead foam article comprising polylactic acid (PLA). As used herein, a “molded bead foam article” refers to an article formed from a polymeric bead foam that has gone through an expansion and bead molding process. The article may be in In some embodiments, the at least one molded bead foam article is an existing molded bead foam article having an initial intended use, such as an insulative piece of PLA-based bead foam included in a product packaging to product a product. In some embodiments, the existing piece of PLA-based bead foam was originally used as thermal protection for temperature-sensitive products, as impact protection for fragile products, or a combination thereof. Rather than discarding this PLA-based bead foam article, it may be used as described herein by modifying it through at least one of (i) machining, (ii) adhesion to another molded bead foam article, (iii) boiling, or (iv) thermoforming to form at least a portion of a customized product packaging.

kit the form of a two-dimensional panel or a three-dimensional structure such as a box or planter. Other polymeric foams are capable of being expanded and molded in a way similar to expandable polystyrene, such as polypropylene, polyethylene, and polylactic acid. In some embodiments, the at least one molded bead foam article has been repurposed from an initial intended use through at least one of (i) machining, (ii) adhesion to another molded bead foam article, or (iii) thermoforming, as described in co-pending U.S. patent application Ser. No. ###. In other words, the at least one molded bead foam article may initially be in the form of a box or panel and was intended for use as a shipper or as insulation in a shipper but is repurposed as a planter by machining, adhesion, or thermoforming the at least one molded bead foam article into a shape suitable as a planter.

It has been unexpectedly discovered that forming the planter out of PLA advantageously permits air and water to pass through the walls of the planter, thereby reducing the likelihood that disease or root rot occur within the planter without resorting to expensive specialty soils. Without intending to be bound by any particular theory, it is believed that the PLA-based molded bead foam article has microscopic voids in between the molded beads that permits oxygen to pass through the planter walls. Since the PLA-based planter is formed from expandable foam, it has a very low weight, especially compared to clay planters. Despite this low weight, the PLA-based planter has sufficient rigidity to maintain its shape and structure when filled with soil and vegetation. Furthermore, the PLA-based planter is not readily broken when, for example, dropped on the ground. Further still, PLA-based molded bead foam is easily composted alongside food and plant waste so the planter can be directly used in the growth of future plants. In other words, the PLA-based planters captures the benefits of both clay planters and plastic planters without their downsides, while adding compostability and the ability to form the PLA-based planter out of existing PLA molded bead foam article(s).

Furthermore, since plant growth is seasonal, planters used as conventional planters, decorative planters, raised beds, seedling cultivation, and hydroponics are all temporary and are typically discarded after approximately 30 days for short growths and up to 800 days for longer term applications. Since clay and plastic planters are impossible or challenging to recycle, these planters typically contribute to waste. By forming the planter and/or various components of these systems from PLA-based molded foam articles, the entire system is compostable which has the potential to dramatically reduce the amount of planter-related waste.

As used herein, a “planter” refers to any container suitable for use as a plant container or pot. For example, in some embodiments, the planter may have a substantially cylindrical shape with a round opening at the top, thereby resembling clay or plastic planters.

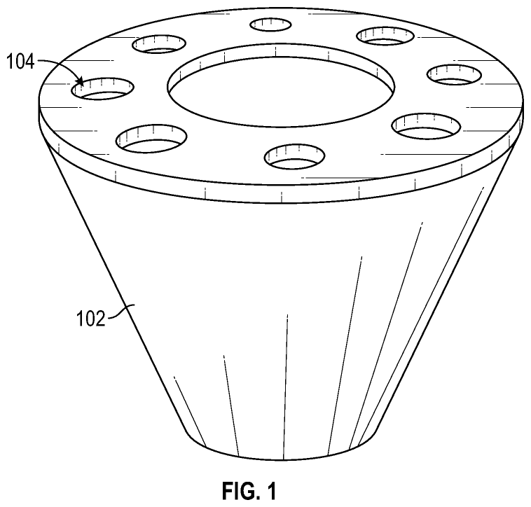

In other embodiments, the planter is in the form of a decorative planter, as depicted in FIG. 1. The decorative planter may comprise a first molded bead foam article 102 having a plurality of holes 104 and a plurality of molded bead foam pots, each molded bead foam pot positioned in one of the holes in the first molded bead foam article. The first molded bead foam article 102 in FIG. 1 is depicted as having a large hole in the center configured to receive a large molded bead foam pot, circled by a plurality of smaller holes. Although the first molded bead foam article 102 in FIG. 1 is depicted as being round with a particular number and arrangement of holes of varying sizes, the first molded bead foam article may have another shape, another quantity of holes, and/or holes of even greater variety of sizes and shapes depending on the needs of the application. The decorative planter may be formed from one or more PLA-based molded bead foam articles and each plant pot housed in the holes of the decorative planter may also be formed from a PLA-based molded bead foam article.

In some embodiments, the planter may be in the form of a raised bed planter configured to separate the plants in the planter from neighboring grass or shrubs. Raised bed planters are commonly used for growing vegetables; PLA-based molded bead foam planks may be easily combined with metal or brick support to form the raised beds, thereby imparting the benefits described above of soil oxygenation and drainage. Since the PLA-based molded bead foam planks are light-weight, the raised beds are easily constructed, positioned, and repositioned. Furthermore,

In some embodiments, the planter may be in the form of a seedling tray including one or more molded bead foam tray having a plurality of cavities and a capillary mat configured to distribute water to the base of each cavity in the molded bead foam tray. Conventional seedling growth solutions rely on traditional plastic materials and capillary mats as separate components. Since the PLA-based molded bead foam tray may be formed into any desired shape through a combination of mold shape and post-molding processes such as machining, adhering, and thermoforming, each cavity may be tailored to have a size and depth suitable for the particular plant being grown and the capillary mat may be incorporated into the same molded foam article. As described above, the molded bead foam tray is easily reused, recycled, and the like, and the plurality of cavities may easily be broken apart into multiple, separate planters for subsequent planting into larger pots without uprooting the seedlings. Since PLA-based molded bead foam is compostable, this repotting process results in the original seedling pot simply contributing to the soil environment as roots of the seedling eventually break through the seedling pot into the surrounding soil. Thus, it has been unexpectedly discovered that forming the seedling tray from PLA contributes to favorable moisture wicking, breathability, thermal insulation, reduced waste, and superior replanting capabilities.

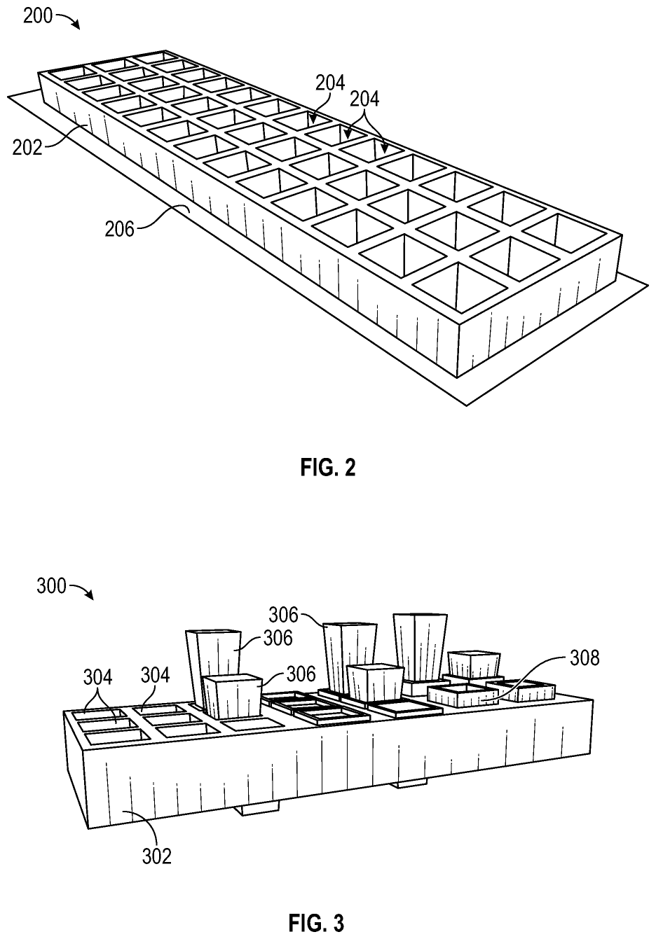

FIG. 2 depicts a planter 200 in the form of a seedling cultivation tray including a molded bead foam tray 202 having a plurality of cavities 204. Tray 202 is positioned above a capillary mat 206 configured to distribute water to the base of each cavity 204. Although the cavities in tray 202 are depicted as squares, they may be cylindrical or another suitable shape. Furthermore, the plurality of cavities in FIG. 2 are depicted in a regular, repeating pattern, but there may be more or fewer cavities in any given row/column, and the cavities may be smaller or larger depending on the needs of the application.

In some embodiments, the planter may be in the form of a hydroponics system including a molded bead foam tray having a plurality of cavities. The planter may include a plurality of molded bead foam plant holders, each plant holder configured to be placed in one of the cavities of the molded bead foam tray. The plant holder may be configured to float on the nutrient-rich solution so that the roots of the plant in the plant holder reach into the solution. Without intending to be bound by any particular theory, it is believed that the low density of PLA-based molded foam articles offers buoyancy even with leaves above the surface. Each plant holder may have an opening configured to permit roots of a plant to pass through. In this way, a plant stored in a plant holder may reach nutrient-rich water as part of the hydroponics system. As described above with respect to seedling cultivation, the PLA-based molded bead foam tray may be formed into any desired shape through a combination of mold shape and post-molding processes such as machining, adhering, and thermoforming, so each cavity may be tailored to have a size and depth suitable for the particular plant being grown to ensure optimal root positioning for the hydroponics system. It has been further unexpectedly discovered that the PLA-based plant holders are capable of “growing” in size as the plant housed within grows in size, something that is not possible with clay or plastic planters.

FIG. 3 depicts a planter 300 in the form of a hydroponics system including a molded bead foam tray 302 having a plurality of cavities 304 and a plurality of plant holders 306. Some cavities have a raised lip 308 that keeps the plant holder 306 at a raised elevation. In this way, the plant holders can easily be repositioned from cavities enabling a lower positioning (such as for plants with short roots) to cavities enabling a higher positioning (such as for plants with longer roots, including those that have grown). Furthermore, as depicted in FIG. 3, the cavities may vary in size depending on the size of the plant holder which, in turn, depends on the size of the plant. Thus, a single molded bead foam tray may be configured for hydroponic growth of plants of varying sizes and/or through varying stages of plant lifecycle.

In some embodiments, the at least one molded bead foam article is at least partially machined. It has been unexpectedly discovered that machining a molded bead foam article formed from PLA produces up to 50% less waste than a comparable molded bead foam article formed from expandable polystyrene, and the dust that is produced is easily compo stable and biodegradable. As used herein, “machined” refers to the process of cutting, milling and/or shaving the molded bead foam article in order to produce smaller molded foam article(s) or to shape the molded foam article. Machining processes may involve the use of lathes, cutting tools, hot knives, rotary tools, etc. When machining EPS-based articles, micro and macroparticles of EPS are generated in the form of dust. This dust is not only undesirable as a messy byproduct of the machining process, but EPS-based foam dust remains incapable of recycling or composting. In addition, when machining PLA-based articles in a typical milling process using a fine cutting tool rotating at 30,000 rpm, there is a 40-60% reduction in fine particles that are produced compared to EPS-based molded articles under the same machining conditions.

In some embodiments, the at least one molded bead foam article that forms the planter includes predefined guides for guiding the machining process. These guides may include grooves, ridges, indentations, regions of manufactured weakness, and the like that present a visual and/or tactile indication to a user that the molded bead foam article may be machined at that point, or present a mechanical weak point for aiding the machining of the molded foam article. In some embodiments, the predefined guides are a predetermined and regular distance apart so that the user can determine, without the need for external measuring tools, the size and shape of a smaller, machined article that is produced from machining the molded foam article. In some embodiments, the predefined guides are strategically positioned so that a specific, secondary foam article is produced or may be constructed after machining the molded foam article. In this way, the molded bead foam article may be machined into one or more smaller articles having sizes defined by the predefined guides and these smaller articles may be subsequently combined or incorporated into the planter. There may be a plurality of predefined guides so that a user may select the size planter that results from machining the molded foam article. For example, the plurality of predefined guides may enable a user to form a decorative pot from the molded bead foam article(s) that is customized for a particular application and advantageously has a stable structure.

In some embodiments, the planter includes at least two molded bead foam articles that are adhered together using an adhesive. Any suitable adhesive may be used, including cyanoacrylate-based adhesives, polyvinyl acetate adhesives, polyvinyl alcohol (PVA) adhesives, multipurpose spray adhesives, hot melt glues, and more. EPS-based molded articles cannot be joined using typical glues because the solvents present in these glues damage the surface of the EPS and prevent adhesion. By forming the planter using molded bead foam articles formed from PLA, it was unexpectedly discovered that most common glues may be used to adhere two pieces of PLA bead foam articles. Molded foam articles may therefore first be machined as described herein to produce one or more smaller molded foam articles, and these smaller molded foam articles may be glued together to produce the planter, thereby extending the life of the molded foam without waste or even recycling or compost.

In some embodiments, the planter includes at least two molded bead foam articles adhering together without any adhesive. It has been unexpectedly discovered that by cutting a surface of the molded bead foam article to create a “fresh” surface, a first molded bead foam article can be joined with another “fresh” surface on a second molded bead foam article. The joining of these molded bead foam articles produces a bond strength comparable to an uncut molded foam article. This enables the formation of planters that are formed from the joining of two or more molded bead foam articles. In contrast, no such adhesion potential is possible with EPS-based molded articles.

In some embodiments, planters includes at least two molded bead foam articles adhered together by heated at least one surface of a first molded bead foam article using a heating element and pressing the at least one surface against a second molded bead foam article. It has been unexpectedly discovered that heating the surface of the molded bead foam article formed from PLA-based beads can be performed without producing flammable gas. The heating element may be a clothing iron, a heat gun, low-pressure or saturated steam, a heated-platen press having a temperature of between about 85° C. to about 175° C., or water having a temperature of between about 85° C. to about 110° C., such as between about 92° C. to about 98° C. When heating with water having a temperature of between about 92° C. to about 98° C., only between about 3 seconds to about 10 seconds of exposure is needed to sufficiently heat the surface of the PLA-based molded bead foam article, while heating with a heated-platen press requires only between about 0.25 seconds to about 8 seconds. By using a heating element, such as a clothing iron, only the desired surface of the molded bead foam article is heated. It has been unexpectedly discovered that a heated surface of a molded bead foam article may be joined with another molded bead foam article, or two heated surfaces of two molded foam articles formed from PLA may be joined and bonded with a strength comparable to a single molded foam article. Similar bonding has not proven possible with EPS, EPP, or EPE with household appliances such as hair dryer and clothes iron. Instead, hot air welding is necessary to join articles formed from EPP and EPE, which is a process operating at higher temperatures than those achievable with household appliances, necessitating the use of special controls and guards on hot air welding machines. Without intending to be bound by any particular theory, it is believed that PLA-based articles have a glass transition temperature (T_{g}), melting temperature (Tₘ), and degree of crystallinity that is favorable for producing the necessary tackiness upon heating at temperatures achievable with household appliances, steam, or hot water.

In some embodiments, the at least one molded bead foam article is manipulable from a first shape to a second shape by thermoforming, wherein the thermoforming involves contacting the at least one molded bead foam article with water having a temperature of between about 92° C. to about 102° C. for between about 8 seconds to about 30 seconds. It has been unexpectedly discovered that PLA-based molded bead foam articles that have been heated by water having a temperature of between about 85° C. to about 110° C. for between about 8 seconds to about 30 seconds may be shaped by hand, such as by wrapping the molded bead foam article around a cylinder to produce a substantially cylindrical molded foam article. The PLA-based molded bead foam article may instead be heated by a heated-platen press having a temperature of from about 85° C. to about 175° C. This may enable the production of custom-shaped molded foam articles without the need for expensive custom molds, which further enables the formation of the planter. The thermoforming process requires only about 20 seconds of holding the water-heated molded bead foam article in a particular position or shape to induce the molded bead foam article to retain the shape. Therefore, by combining the predefined guides, machining, and/or thermoforming, planters of a variety of shapes and sizes may be formed from one or more PLA-based molded bead foam articles, even if the molded bead foam articles vary in their initial shapes and intended purposes.

In some embodiments, the at least one molded bead foam article has a shape, wall thickness, and density suitable for use as a planter without modification. For example, a cuboid-shaped molded bead foam article used as a shipper may be used, without modification, for house plants. It has been unexpectedly discovered that PLA bead foam articles allow excess water to evaporate from side walls and base, preventing root rot common with plastic pots. Furthermore, evaporating water from the walls of the molded foam article result in evaporative cooling similar to the clay pots, thereby decreasing soil temperature spikes by around 20° F. than a plastic pot.

The conventional approach to manufacturing plastic resin planters involves injection molding a single piece, which is a cost-effective but limiting process. However, by forming the planters from PLA-based molded bead foam, a vertical wire-cutting method can be employed to separate a box-shaped molded bead foam article into two segments, enabling the conversion of a planter lid into a detachable sidewall on the PLA-based bead foam planter. This detachable sidewall feature may enable effortless extraction of plants during transplanting or repotting activities. The ability to cut a planter using a wire-cutter is not possible in clay or plastic planters. Therefore, in some embodiments, the lid of a PLA bead foam article may be deconstructed into a plurality of foam pieces which may be used in the bottom of the molded foam planter as aeration amplifiers or on the sides of the molded foam planter to enable easy plant removal. Typical potted plants employ pine bark and wood chips to provide aeration, but these materials are prone to absorb moisture and rot or grow fungus. In some embodiments, the foam article can be used to insulate a raised bed garden.

In some embodiments, the at least one molded bead foam article has a shape and wall thickness suitable for use as a support to a retaining wall. For example, the planter may be a raised bed planter that may be easily constructed from PLA bead foam articles to support soil. Retaining walls often suffer from soil loss near the wall and suffer from excess load/force from soil on the wall. A foam surface parallel to the wall can decrease the load and prevent gaps from forming between the wall and the soil. Since soil has a density of between about 150-170 pcf and the molded bead foam article has a density of about 1.3 pcf, incorporation of the molded bead foam article as support for a retaining wall translations to a weight reduction of 1000 pounds per 6 ft² of wall area.

In some embodiments, the at least one molded bead foam article is configured as a kit or part of a kit designed to be machined, adhered or thermoformed into the planter. For example, the at least one molded bead foam article may include predefined guides that, when machined, produce a plurality of smaller bead foam articles designed to be combined in a specific way to form a planter of a predetermined size and shape, i.e., as a kit.

In some embodiments, the at least one molded bead foam article is an existing molded bead foam article having an initial intended use, such as an insulative piece of PLA-based bead foam included in a product packaging to product a product. In some embodiments, the existing piece of PLA-based bead foam was originally used as thermal protection for temperature-sensitive products, as impact protection for fragile products, or a combination thereof. Rather than discarding this PLA-based bead foam article, it may be used as described herein by modifying it through at least one of (i) machining, (ii) adhesion to another molded bead foam article, (iii) boiling, or (iv) thermoforming to form at least a portion of a customized product packaging.

Methods for Producing Planters

Methods for producing planters are also disclosed herein. In one aspect, the methods include producing planters as described above. In another aspect, the method includes molding a plurality of foam beads including polylactic acid to produce at least one molded bead foam article, wherein the at least one molded bead foam article is configured for use as a planter. In some embodiments, the method includes subjecting the at least one molded bead foam article to at least one secondary process to form the custom product packaging. In some embodiments, the secondary process comprises (i) machining, (ii) adhesion to another molded bead foam article, (iii) thermoforming.

In some embodiments, the at least one secondary process includes machining the at least one molded foam article, wherein machining the at least one molded bead foam article produces less dust relative to a comparable molded bead foam article formed from expandable polystyrene. In some embodiments, the molding process includes providing predefined guides on the at least one molded bead foam article for guiding the machining of the at least one molded bead foam article. In some embodiments, the predefined guides are a predefined distance apart. In some embodiments, the method includes producing one or more molded foam panels using the predefined guides when the at least one molded bead foam article is machined along the predefined guides.

In some embodiments, the method includes producing at least two molded bead foam articles and adhering a first molded bead foam article to a second molded bead foam article using an adhesive. In some embodiments, the adhesive is selected from (i) cyanoacrylate, (ii) polyvinyl acetate, or (iii) a hot melt adhesive. Any suitable adhesive may be used because PLA bead foam articles are capable of adhesion using any suitable adhesive. In contrast, expandable polystyrene is not capable of adhesion using most common household glues.

In some embodiments, the method includes producing at least two molded bead foam articles, heating a surface of a first molded bead foam article using a heating element, heating a surface of a second molded bead foam article with the heating element, and adhering the first molded bead foam article to the second molded bead foam article by pressing the heated surfaces together. In some embodiments, heating the molded bead foam article using a heating element does not produce flammable gas. In contrast, expandable polystyrene is produced using pentane as a blowing agent, which is a flammable gas; heating EPS-based molded articles carries the risk of igniting residual pentane. In some embodiments, the heating element is a clothing iron, a heat gun, or water having a temperature of 92° C. to 102° C. In some embodiments, the heating element is water having a temperature of 92° C. to 102° C. and the water is applied for 3-10 seconds.

In some embodiments, the method includes heating the at least one molded bead foam article using water having a temperature of 85° C. to 110° C. for 8-30 seconds, and thermoforming the heated molded bead foam article from a first shape to a second shape. In some embodiments, the method includes heating the at least one molded bead foam article using a heated-platen press having a temperature of 85° C. to 175° C. for 0.25-8 seconds, and thermoforming the heated molded bead foam article from a first shape to a second shape. In some embodiments, the method includes heating the at least one molded bead foam article using a heating element that includes a clothing iron, a heat gun, or low-pressure or saturated steam, and thermoforming the heated molded bead foam article from a first shape to a second shape.

In some embodiments, the method includes molding a molded bead foam article having a shape, wall thickness, and density suitable for use as a planter without further modification.

In some embodiments, the method includes molding a molded bead foam article having a shape and wall thickness suitable for use as a support to a retaining wall. One can also obtain the shape using adhesives, machining and self-adhesion described previously.

### EXAMPLES

The disclosure may be further understood with reference to the following non-limiting examples.

### Example 1: Use of PLA Bead Foam Article as a Planter

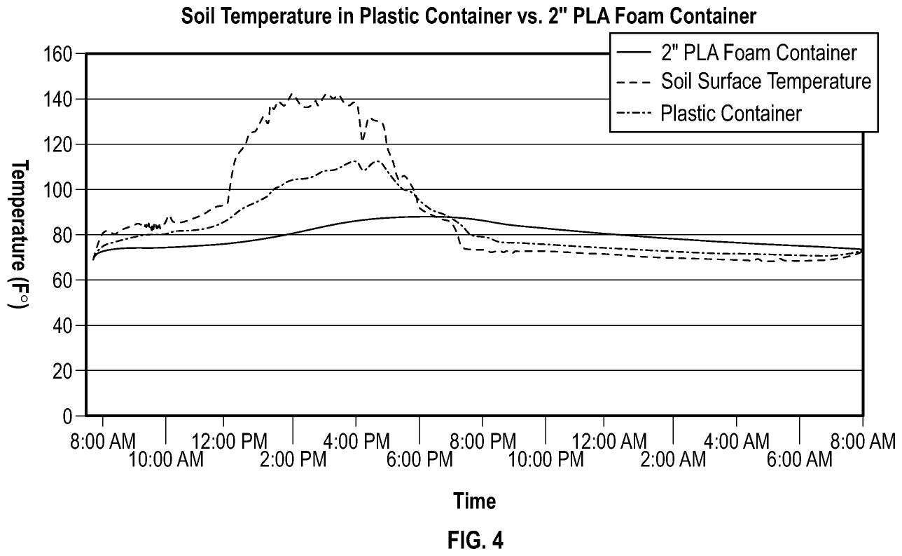

A PLA bead foam article was formed as described herein and used as a planter. The temperature of the soil was measured for the PLA bead foam article planter and a typical plastic pot planter. The results are displayed in FIG. 4. The soil surface temperature was measured at a depth of 1 inch from the soil surface, while the soil temperature was measured 3 inches from the soil surface. The soil temperatures were measured in August in Belcamp, Maryland, with a high temperature of 90° F. and humidity of 76%. It was unexpectedly discovered that the soil temperature was 20° F. lower for the PLA bead foam article planter than the plastic pot, indicating greater moisture evaporation. This increased moisture evaporation favorably reduces stagnant water which may contribute to root rot and mildew growth. Maintaining a constant soil temperature is generally beneficial for germinating seeds as young seedlings are sensitive to temperature changes.

### Example 2: Cost of Soil Analysis

A study was conducted to evaluate the cost variability of soil and the diverse range of specifically formulated soil types available for container and planter gardening purposes. To achieve this, six commercially available soil types were purchased: the Sta-Green 32-Quart Potting Soil Mix, Scotts® Premium 0.75-cu ft topsoil, Miracle-Gro® All Purpose for In-Ground Use 1.5-cu ft Garden Soil, Miracle-Gro® Cactus, Palm & Citrus 8-Quart Potting Soil Mix, Leafgro® 40-lb Organic Compost, and Rosy Soil Indoor Potting Mix. The prices of each soil type used in the study were analyzed and the breakdown per quart is presented in Table 1.

TABLE 1
Cost of Soil

| Soil Type | Price | Cubic Ft | quart | price/qt |
|---|---|---|---|---|
| Leafgro® 40-lb Organic Compost | $5.78 | 1.5 | 45 | $0.13 |
| Scotts® Premium 0.75-cu ft topsoil | $2.98 | 0.75 | 22 | $0.13 |
| Miracle-Gro® All Purpose for | $4.58 | 0.75 | 22 | $0.20 |
| In-Ground Use 1.5-cu ft Garden Soil | | | | |
| Sta-Green 32-Quart Potting Soil Mix | $8.98 | 1.07 | 32 | $0.28 |
| Miracle-Gro® Cactus, Palm & Citrus 8- | $8.98 | 0.27 | 8 | $1.12 |
| Quart Potting Soil Mix | | | | |
| Rosy Soil Indoor Potting Mix | $25.00 | 0.27 | 8 | $3.12 |

Highly aerated soil mixes, such as the cactus/palm/citrus soil, are almost ten times the cost of regular topsoil at $1.12 per quart. Furthermore, specialty potting mixes, such as Rosy Soil's sustainable and peat-free alternative, can be prohibitively expensive for some gardeners, with prices averaging at $3.12 per quart. The high cost of these mixes is attributed to their unique blend of organic materials that have been carefully selected to optimize plant growth and proper aeration without relying on peat moss.

The study highlights that soil types that are specially formulated for planter and container gardening are significantly more expensive than standard in-ground use soil. Furthermore, the analysis revealed that some of these soil types have been designed to cater to the unique requirements of container and planter gardening, while others are specifically labeled for in-ground use. Notably, one of the soil types analyzed in this study is specifically formulated for three plant species, namely, cactus, palm, and citrus.

### Example 3: Comparison of Watering Vs. Moisture Level

A study was conducted to investigate the impact of container type on soil drying. The experiment involved using two types of containers: one group made of 1.5″ thick PLA-based planters with a cubic volume of 6.65 quarts, and the other group comprising standard plastic resin planters with a cubic volume of 6.67 quarts. The containers were filled with soil specifically formulated for container or planter gardening, such as potting mix and cactus/palm/citrus soil mix. The objective was to determine the effect of container type on soil drying, considering the natural aeration and drying properties of the soil mixes.

The moisture level of the soil in each planter was measured using two commercially available soil meters, namely the Raintrip Soil Meter and the Classy Casita™ Soil Moisture Sensor, both of which operate based on the electrical conductivity of the soil and the corresponding level of resistance. The moisture meters generate a reading on a scale of 1 to 10. The readings from the two meters were averaged before reporting.

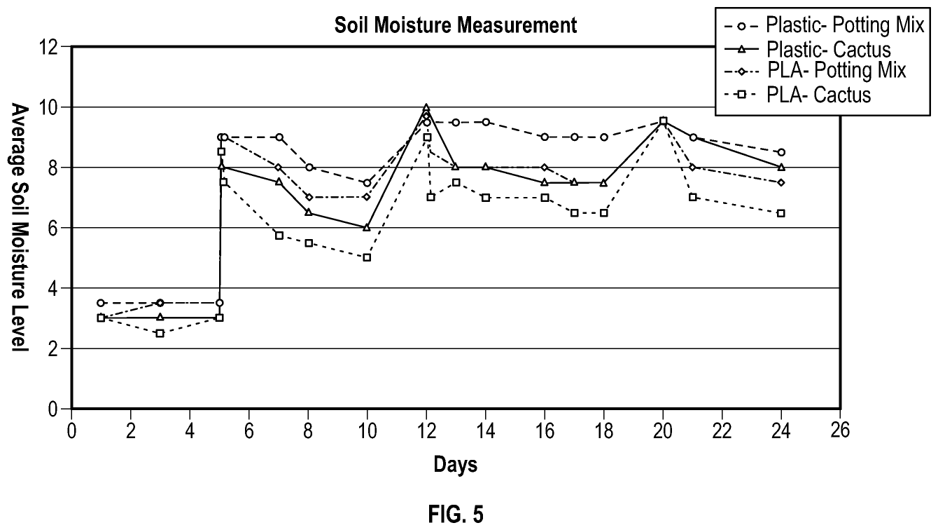

To obtain the moisture readings, the probe was inserted roughly 1 inch from the bottom of the container in the center of the container. On Day 1, the initial moisture levels were measured after the containers were filled. The moisture readings were made daily in the morning. Five days were allowed to let the containers equilibrate at an ambient temperature of 70-72° F. and relative humidity between 40-50%. One cup of water was poured at the top surface of container on Day 6. After six days without water, 3 cups of water were added on Day 12. Finally, 6 cups of water were added on Day 14. The results of the moisture measurements are displayed in FIG. 5.

It was observed that during each watering period, the PLA containers lost moisture much faster than the plastic containers, indicating that the PLA containers are providing additional routes for moisture evaporation, mainly sides and bottom of the container. The graph shows the moisture measurements recorded for the potting mix and the cactus/palm/citrus soil.

The moisture level was measured at 10 and 30 minutes after pouring the water, and daily after that, to analyze the drying behavior of the soil medium with the container. The 3 cups of water on Day 12 resulted in leakage of water from the drainage holes from bottom of plastic pots. With the 6 cups of water on Day 14, higher amount of leakage from drainage holes from bottom was observed with the plastic pots and smaller amount with PLA container.

It is worth noting that vegetation plays a significant role in the drying of soil due to water absorption by the plant roots. However, prolonged soil wetness can lead to the development of root rot, as well as other fungal and bacterial problems, emphasizing the importance of understanding soil drying characteristics to maintain healthy plant growth. It was observed that during each watering period, the PLA containers lost moisture much faster than the plastic containers. This indicates that the ePLA containers provide faster evaporation of moisture. While the graph in FIG. 5 may lead to the conclusion that PLA containers wasted water by allowing it to escape from the sides of the containers, having soil that dries faster can be seen as more efficient because it protects plants from root rot and other ailments that can result from excess moisture in the soil. When soil stays wet for extended periods, it can lead to the growth of harmful bacteria and fungi, which can damage the roots and weaken the plant. Additionally, excess moisture drainage can lead to nutrient leaching out of the pot or nutrient redistribution within the pot. By allowing the soil to dry faster, the risk of these problems is reduced, leading to healthier plants and more efficient water usage.

### Example 4: Drying Behavior of Garden Soil

An additional study was conducted to test the drying behavior of “in-ground use” garden soil in plastic pots and PLA-based bead foam containers. Garden soil typically lacks essential components for adequate drying and aeration in containers or planters. Given that PLA-based bead foam containers have lateral walls which provide aeration, an evaluation of the drying behavior of this soil was tested. The trial was also conducted without any added vegetation under ambient conditions of 70-72° F. and a relative humidity of 40-50%.

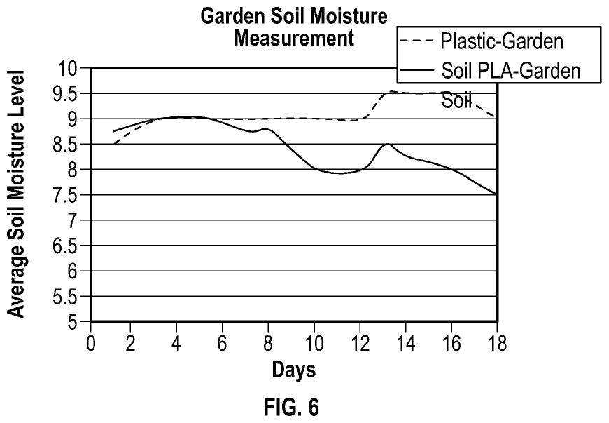

Following the filling of containers up to 1″ from the top with garden soil, the moisture level of the soil was measured using the same moisture meters and principles as described in Example 3. The results are displayed in FIG. 6.

The initial moisture content of the soil was 8.5-9, and it took five days before the PLA-based bead foam container began to dry. Throughout the experiment, the garden soil in the plastic container remained at a moisture level of above 9, while the garden soil in the PLA-based bead foam container continued to trend downward for 18 days, resulting in a moisture content of 7.5. FIG. 6 illustrates how the PLA container was able to dry the soil, even without any additives such as perlite, wood pieces, vermiculite, or any other components that aid in drying and aeration. These soil additives increase soil cost while providing similar moisture retention properties obtained with garden soil in PLA-based bead foam containers. With added vegetation also absorbing water, it should be feasible to cultivate plants in PLA containers without resorting to specialized, expensive soil solutions.

### Example 5: Analyzing Water Absorption

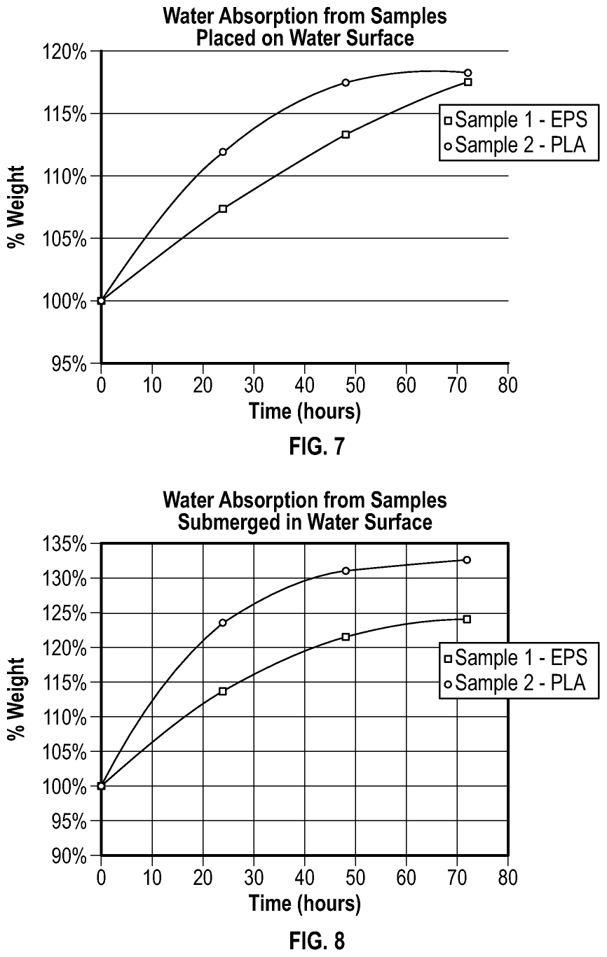

An EPS plank and a PLA-based bead foam plank were molded and placed on the surface of a container of water. The planks of EPS and PLA were wire cut and had dimensions of 1.5″×3″×4″. The 3″×4″ surface was in contact with water. The density of both materials was 0.02 g/cm³. Both EPS and PLA bead foam have micropores enabling the absorption of water, so the planks were analyzed for water absorption by measuring an initial plank weight and the weight of the plank over time. The results of the analysis are displayed in FIG. 7 for planks placed on the water surface, and FIG. 8 for planks submerged just below the water surface.

As displayed in FIGS. 7 and 8, the PLA-based bead foam plank outperformed the EPS plank material in terms of water absorption rate. Specifically, the PLA-based planks placed on top of the water surface exhibited a weight gain of 18%, while it took the EPS plank 72 hours to reach the same weight gain. These findings suggest that the PLA-based bead foam is a highly effective medium for use in hydroponic and capillary trays, as it can rapidly and efficiently absorb water and nutrients and distribute it evenly to plant roots.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

That which is claimed is:

1. A planter comprising at least one molded bead foam article comprising polylactic acid.

2. The planter of claim 1, wherein the at least one molded bead foam article has been repurposed from an initial intended use through at least one of (i) machining, (ii) adhesion to another molded bead foam article, or (iii) thermoforming.

3. The planter of claim 1, wherein the planter comprises:
a first molded bead foam article having a plurality of holes, and
a plurality of molded bead foam pots, each molded bead foam pot positioned in one of the holes in the first molded bead foam article.

4. The planter of claim 1, wherein the at least one molded bead foam article comprises a molded bead foam tray having a plurality of cavities, and wherein the planter further comprises:
a capillary mat, wherein the capillary mat is configured to distribute water to a base of each cavity in the molded bead foam tray.

5. The planter of claim 1, wherein the at least one molded bead foam article comprises a molded bead foam tray having a plurality of cavities, and wherein the planter further comprises:
a plurality of molded bead foam plant holders, each plant holder configured to be placed in one of the cavities, wherein each plant holder has an opening configured to permit roots of a plant to pass through.

6. The planter of claim 1 wherein, when the at least one molded bead foam article is at least partially machined.

7. The planter of claim 6, wherein machining the at least one molded bead foam article produces less dust than a comparable molded bead foam article formed from expandable polystyrene.

8. The planter of claim 1, wherein the at least one molded bead foam article comprises predefined guides for guiding the machining of the molded bead foam article.

9. The planter of claim 8, wherein the predefined guides are spaced a predefined distance apart.

10. The planter of claim 8, wherein the predefined guides are defined such that, when the molded bead foam article is machined along the predefined guides, one or more molded foam panels are produced corresponding to the planter.

11. The planter of claim 1, wherein the planter comprises at least two molded bead foam articles adhered together using an adhesive.

12. The planter of claim 11, wherein the adhesive is selected from (i) polyvinyl acetate, or (ii) a hot melt adhesive.

13. The planter of claim 1 wherein the planter comprises at least two molded bead foam articles adhered together by heating at least one surface of a first molded bead foam article using a heating element and pressing the at least one surface against a second molded bead foam article.

14. The planter of claim 13, wherein heating the at least one surface of the first molded bead foam article is performed without producing flammable gas.

15. The planter of claim 13, wherein the heating element comprises a clothing iron, a heat gun, saturated steam, a heated-platen press having a temperature of 85° C. to 175° C., or water having a temperature of 85° C. to 110° C.

16. The planter of claim 13, wherein the heating element comprises water having a temperature of 88° C. to 110° C., and the water is applied for 3-10 seconds.

17. The planter of claim 1, wherein the at least one molded bead foam article is manipulable from a first shape to a second shape by thermoforming, wherein the thermoforming comprises (i) contacting the at least one molded bead foam article using water having a temperature of 85° C. to 110° C. for 8-30 seconds, (ii) contacting the at least one molded bead foam article using a heated-platen press having a temperature of 85° C. to 175° C. for 0.25-8 seconds, or (iii) contacting the at least one molded bead foam article with a heating element that includes at least one of a clothing iron, a heat gun, or low-pressure or saturated steam.

18. The planter of claim 1, wherein the at least one molded bead foam article has a shape, a wall thickness, and a density suitable for reducing temperature fluctuation.

19. The planter of claim 1, further comprising a lid configured to be deconstructed into a plurality of foam pieces for use as aeration amplifiers in the planter.

20. The planter of claim 1, wherein the planter is a raised bed planter, and the at least one molded bead foam article has a shape and wall thickness suitable for use as a support to a retaining wall.

21. The planter of claim 1, wherein the at least one molded bead foam article is configured as a kit or a part of a kit designed to be thermoformed into the planter.

22. A method for producing a planter comprising:
molding a plurality of foam beads comprising polylactic acid to produce at least one molded foam article, wherein the at least one molded bead foam article is configured for use as a planter.

23. The method of claim 22, further comprising subjecting the at least one molded bead foam article to at least one secondary process to form the planter, wherein the secondary process comprises (i) machining, (ii) adhesion to another molded bead foam article, or (iv) thermoforming.

24. The method of claim 23, wherein the at least one secondary process comprises machining the at least one molded foam article, wherein machining the at least one molded bead foam article produces less dust relative to a comparable molded bead foam article formed from expandable polystyrene.

25. The method of claim 22, wherein the molding process further comprises providing predefined guides on the at least one molded bead foam article for guiding machining of the at least one molded bead foam article.

26. The method of claim 25, wherein the predefined guides are spaced a predefined distance apart.

27. The method of claim 25, further comprising machining the at least one molded bead foam article along the predefined guides to produce one or more molded bead foam panels.

28. The method of claim 22, wherein molding the plurality of foam beads produces at least two molded foam articles, and wherein the method further comprises:
adhering a first molded bead foam article to a second molded bead foam article using an adhesive.

29. The method of claim 22, wherein the adhesive is selected from (i) polyvinyl acetate, or (ii) a hot melt adhesive.

30. The method of claim 22, wherein molding the plurality of foam beads produces at least two molded foam articles, and wherein the method further comprises:
heating a surface of a first molded bead foam article with a heating element,
heating a surface of a second molded bead foam article with the heating element, and
adhering the first molded bead foam article to the second molded bead foam article by pressing the heated surfaces together.

31. The method of claim 30, wherein the heating element comprises a clothing iron, a heat gun, low-pressure steam, saturated steam, a heated-platen press having a temperature of 85° C. to 175° C., or water having a temperature of 85° C. to 110° C.

32. The method of claim 30, wherein the heating element comprises (i) water having a temperature of 88° C. to 110° C., and wherein the water is applied for 3-10 seconds, or (ii) a heated-platen press having a temperature of 85° C. to 175° C., and wherein the heated-platen press is applied for 0.25-8 seconds.

33. The method of claim 22, further comprising:
heating the at least one molded bead foam article using (i) water having a temperature of 85° C. to 110° C. for 8-30 seconds, (ii) a heated-platen press having a temperature of 85° C. to 175° C., or (iii) at least one molded bead foam article with a heating element that includes at least one of a clothing iron, a heat gun, or low-pressure or saturated steam, and
thermoforming the at least one heated molded bead foam article from a first shape to a second shape.

34. The method of claim 22, wherein the molded bead foam article has a shape, a wall thickness, and a density suitable for use as a planter without modification.

35. The method of claim 34, wherein one of the at least one molded bead foam articles comprises a lid, and wherein the method further comprises deconstructing the lid into a plurality of foam pieces for use as aeration amplifiers in the planter.
